(19) United States
(12) Patent Application Publication
(10) Pub. No.: US 2014/0185154 A1
(43) Pub. Date: Jul. 3, 2014

(54) OUTSIDE MIRROR ARRANGEMENT FOR A MOTOR VEHICLE

(71) Applicant: GM GLOBAL TECHNOLOGY OPERATIONS LLC, Detroit, MI (US)

(72) Inventor: Adrian ACKER, Bodenheim (DE)

(73) Assignee: GM GLOBAL TECHNOLOGY OPERATIONS LLC, Detroit, MI (US)

(21) Appl. No.: 14/091,360

(22) Filed: Nov. 27, 2013

(30) Foreign Application Priority Data
Nov. 29, 2012 (DE) 10 2012 023 269.1

(51) Int. Cl. B60R 1/06

(52) U.S. Cl. CPC B60R 1/06
USPC 359/871; 29/428

(57) ABSTRACT

An outside mirror arrangement is provided for a motor vehicle with a mirror, a mirror housing encasing the mirror and with a fastening element, which for the sealing fastening of the mirror housing to a motor vehicle body that includes, but is not limited to at least one seal, on which in a pre-assembly state of the outside mirror arrangement a sealing part is detachably fastened, which prior to fastening the mirror housing to the motor vehicle body can be separately fastened to the body.

### CROSS-REFERENCE TO RELATED APPLICATION

This application claims priority to German Patent Application No. 10 2012 023 269.1, filed Nov. 29, 2012, which is incorporated herein by reference in its entirety.

### TECHNICAL FIELD

The technical field relates to an outside mirror arrangement for a motor vehicle, with a mirror, a mirror housing encasing the mirror and with a fastening element, which is designed for the sealing fastening of the mirror housing to a motor vehicle body.

### BACKGROUND

Outside mirrors are typically arranged on the front doors of a motor vehicle. Based on the travelling direction of the motor vehicle, they can be fastened to the door structure of a motor vehicle body in front of a lowerable window pane, for example in the region of a so-called mirror triangle. It is conceivable, furthermore, to provide the outside mirror approximately in a transition region of a lowerable front side window to a typically fixed triangular window located in travelling direction in front of such a lowerable front side window.

Irrespectively of their concrete connecting location on the motor vehicle body, popular outside mirror arrangements comprise a fastening element in addition to a housing encasing the mirror, which has an approximately plate-like or predominantly planar or flat design and which, located approximately in the plane of the lowerable window, can be fastened to the door structure. The fastening element can be arranged on the door structure approximately adjoining a front window guide rail. Towards the bottom, it can for example extend as far as to a trim molding limiting the window well of the door structure, while towards the top, viewed in vehicle vertical direction (z), it can project as far as to a door profile following the A-pillar of the motor vehicle body.

The fastening element of an outside mirror arrangement is typically formed in one piece with the housing of the outside mirror arrangement. At least, an outer covering of the mirror housing can be seamlessly merged into an outer covering of the fastening element. The fastening element is to be fastened in particular sealingly to the door structure of the motor vehicle body in order to effectively prevent dirt and moisture for example entering the interior of the door structure.

Based on the vehicle vertical direction (z), a typical door structure of a motor vehicle body has a hollow space between door outer paneling and door inner covering in the region below a mirror connecting region, which likewise has to be protected from ingress of moisture and/or of dust or dirt. Furthermore, such a hollow space can have a disadvantageous effect on the vibration behavior and the acoustic characteristics of the door structure, hence the entire motor vehicle body. For this reason, the hollow space provided below the mirror connecting region of the door structure is separately provided with a sealing part, which for example can fill out said hollow space in an accurately fitting manner.

Thus, DE 10 2010 023 492 A1 for example describes a sealing arrangement for a mirror triangle of a motor vehicle door with at least one guide and/or sealing rail arranged on the outside of the mirror triangle. Here, a sealing flap is arranged on the guide and/or sealing rail, which at least partially extends in a region of the mirror triangle of the motor vehicle door located inside of the guide and/or sealing rail.

For the mass production of motor vehicles it is necessary furthermore that the components provided for the respective installation or assembly step are available according to schedule at the place of installation corresponding to the overall production process. The separate and isolated provision of a sealing part specifically provided for filling the hollow space before the assembly of an outside mirror arrangement thus requires a certain degree of logistics. In a similar way as for the outside mirrors proper, a left and a right sealing part have to be distinguished, which accordingly are to be arranged on the left and right motor vehicle door respectively.

In view of the foregoing, at least one object is to simplify the assembly of an outside mirror arrangement on a motor vehicle or on a motor vehicle body and in the process reduce in particular the logistical effort for handling and providing individual assembly components. In this regard, the present invention pursues a reduction of the assembly effort and of the assembly costs for the outside mirror fastening on the motor vehicle. In addition, other objects, desirable features and characteristics will become apparent from the subsequent summary and detailed description, and the appended claims, taken in conjunction with the accompanying drawings and this background.

### SUMMARY

In this regard, an outside mirror arrangement for a motor vehicle is provided, which comprises a mirror and a mirror housing encasing the mirror. The outside mirror arrangement is provided furthermore with a fastening element, which for the sealing fastening of the mirror housing to a motor vehicle body comprises at least one seal. The fastening element in this case can be formed in one piece with the mirror housing and can for example extend in or parallel to the plane of the motor vehicle side window of the motor vehicle door. With the seal provided on the fastening element, hence the mirror housing, it can be largely sealingly arranged on a door structure of a motor vehicle body.

In a pre-assembly state of the outside mirror arrangement, a sealing part is loosely fastened to the seal of the fastening element. This can be separately fastened to the body prior to fastening the mirror housing to the motor vehicle body. The pre-assembly state in this case describes the state of the outside mirror arrangement, in which the latter can be or is typically provided by a motor vehicle supplier, for example on the assembly line of a motor vehicle manufacturer.

In that the sealing part is detachably fastened to the seal that is provided on the fastening element of the outside mirror arrangement and arranged thereon, the sealing part which has to be arranged on the motor vehicle body separately and independently of the mirror housing, can form a structural unit with the outside mirror arrangement at least pending the final assembly on the motor vehicle or be designed as an integral but detachable part of the outside mirror arrangement.

In this way, a separate handling and accordingly logistical effort for the separate sealing part can be advantageously omitted. In addition, the matching sealing part is quasi automatically or inherently made available for each conceivable outside mirror arrangement. Thus, a right outside mirror arrangement is provided with a sealing part to be arranged on the right body side, which can similarly apply to a left outside mirror arrangement.

With respect to assembly, the detachable arrangement of the sealing part on the seal of the fastening element of the outside mirror arrangement offers various advantages. Thus, the sealing part can be manually and directly detached from the seal of the fastening element on the mirror side in particular by the assembler. Consequently, for example prior to the assembly of the mirror housing on the motor vehicle body, the detached sealing part can be initially arranged on the motor vehicle body as intended, before the mirror housing is finally fastened to the body.

According to an embodiment, the sealing part and the seal of the fastening element in a pre-assembly state of the outside mirror arrangement are connected to one another in a positively joined or materially joined manner. Thus, the sealing part for example can be connected to the seal of the fastening element of the outside mirror arrangement with a fastening clip or comparable positive connection means separately provided for this purpose. It is conceivable, furthermore, that the sealing part is connected to the seal for example in a materially joined, but in a defined way, detachable manner. Thus, the seal and the sealing part can for example be welded or glued to one another in such a manner that by exerting a peeling force above a predetermined threshold value, which welded or glued connection, can be disconnected in a controlled manner. By forming a positively joined or materially joined connection of sealing part and seal, different materials almost as required can be used for the seal and the sealing part.

According to an embodiment, the sealing part and the seal are formed in one piece in the pre-assembly state of the outside mirror arrangement. This means, the seal and the sealing part have one and the same material and are preferably producible in one and the same production process. Here it is provided in particular that exclusively the seal can be exclusively connected to the fastening element of the outside mirror arrangement and that the sealing part merely functions as a detachable extension of the seal.

A one-piece configuration of seal and sealing part is advantageous in particular from a production point of view. Thus, seal and sealing part can be produced with only a single operation and with a further operation, can for example be connected to the fastening element of the outside mirror arrangement. In addition, through a one-piece configuration of seal and sealing part, a separate mutual fastening of seal and sealing part can be advantageously omitted.

According to an embodiment, the sealing part is connected to the seal via at least one predetermined breaking point or via a predetermined breaking line. The predetermined breaking point in this case can be formed in particular in a connecting portion between sealing part and seal. Thus, the connecting portion between sealing part and seal can in particular comprise a structural weakening or a structural weakening structure functioning as a predetermined breaking point, which on exertion of a force above a predetermined and defined threshold value can lead to a defined separating of seal and sealing part, and which, each considered in isolation, keeps the sealing part and the seal intact.

Here it can be provided in particular that the connection of sealing part and seal is in the form of a plurality of connecting webs, which through their geometrical configuration, in particular through a geometrical configuration which is filigreed compared with the proportions of seal and sealing part exhibit a desired tear-off or separation behavior.

According to a further embodiment, the sealing part in the pre-assembly state of the outside mirror arrangement can project from the seal or from the fastening element. Here, the sealing part can extend outwardly from a lateral edge of the seal or of the fastening element. Furthermore, it can extend substantially away from the plane formed by the fastening element or by the seal. It is additionally conceivable, that the detachable sealing part extends at a predetermined angle to the plane of the fastening element or to the plane of the seal fastened thereon.

Depending on the mutual arrangement of sealing part, seal and fastening element it can even be achieved that for arranging the fastening element, thus of the outside mirror arrangement on the motor vehicle body, the sealing part provided thereon has to be initially detached in order that the fastening element can be at all fastened in an accurately fitting manner to a mirror connecting region of the motor vehicle body.

Thus it can be provided, in particular, that the sealing part is approximately arranged on the side of the fastening element facing away from the mirror housing, so that it respectively prevents an intended arranging of the fastening element on the mirror connecting region of the motor vehicle body without prior removing of the fastening element. In this regard, the detachable arrangement of the sealing part in the pre-assembly state of the outside mirror arrangement can contribute to the sealing part being arranged as intended and not for example being lost during the assembly process.

According to a further embodiment, the seal encloses the fastening element substantially in circumferential direction. The seal can in particular be formed as a sealing profile, which in particular can interact in a positively joined manner with fastening device of the fastening part designed correspondingly therewith. In this regard, the seal or the sealing profile can be designed as a sealing frame, with which the fastening element of the outside mirror arrangement can be surroundingly sealable with respect to the adjoining profiles, guide rails or trim moldings of a motor vehicle door structure.

Finally, according to a further embodiment, the sealing part which is separated from the seal can be inserted in a hollow space of the motor vehicle door structure formed below a mirror connecting region on the body side. Here, the sealing part can in particular function as a filling piece, which fills out a hollow space which of necessity materializes or is formed in the door structure below a mirror connection. Here, the sealing part can counteract the development of mechanical vibrations and the propagation of resonance phenomena, which could otherwise spread unchecked over the hollow space into the motor vehicle door structure. Furthermore, the sealing parts can seal the hollow space of the motor vehicle structure, in particular towards the top, in vehicle vertical direction (z) and thus effectively protect against the entering of moisture and/or dirt.

It is provided in particular that the sealing part is arranged approximately in an extension of a window well directed in vehicle longitudinal direction. Thus, the sealing part in the final assembly state comes to lie approximately in the region of the belt line of the motor vehicle body.

According to a further embodiment, the sealing part projects from an outer circumference of the seal and/or an outer circumference of the fastening element in the pre-assembly state. Here it can be provided in particular that the sealing part projects from a lower end portion of the seal or from a lower end portion of the fastening element of the outer mirror arrangement. In this way, the mutual arrangement of sealing part and seal can already characterize the intended final installation position or the relative positioning of seal, fastening element and sealing part to one another even in the pre-assembly state of the outside mirror arrangement. As a consequence of this, in particular through the manner of the detachable connecting of the sealing part to the seal or to the fastening element of the outside mirror arrangement the assembler can be provided with an intuitive assembly hint.

According to a further embodiment, the sealing part can be arranged in the final assembly state on the motor vehicle body in the region of a belt line of the body, directly adjoining the seal of the fastening element of the outside mirror arrangement fastened to the body. Here it is conceivable in particular that the sealing part which is to be separately fastened to or arranged on the motor vehicle body and the seal of the fastening element mutually come into contact with each other or even form an overlap region. Since both the seal as well as the sealing element are preferably formed elastically, an improved sealing effect can be achieved through a mutual contact position of seal and sealing part.

According to a further embodiment, the seal and/or the sealing part which is configured detachable there from are designed as a foamed plastic molding. However, seals and sealing parts are also conceivable, which comprise an elastomer material, for example a synthetic or natural rubber. For the seal and for the sealing part, a heat-curable or thermally activatable polyethylene foam is possible in particular. The seal as well as the sealing part can in particular be provided in a required outer contour with the help of a molding tool. For forming a comparatively filigreed and short connecting region between the seal and the sealing part, an orientation of seal and sealing part at a predetermined angle, for example between approximately 0° and 180° can be advantageously provided here.

A configuration angled or bent accordingly is advantageous in particular for a one-piece design of seal and sealing part. On the one hand, a comparatively short connecting region which hardly or only imperceptibly influences the installation of seal and sealing part can be created because of this. In addition, an orientation of seal and sealing part thus bent or angled proves to be advantageous for the configuration, in particular for the mechanical stability of the molding tools to be provided for this purpose.

In a further embodiment, a motor vehicle body with at least one outside mirror arrangement described before is finally provided. The motor vehicle body in this case comprises in particular a door structure, in particular a side door, on which the outside mirror arrangement is arranged in the manner described before. Finally, according to a further aspect, a corresponding motor vehicle is provided, which either comprises a motor vehicle body described before or which comprises at least one outside mirror arrangement described before. According to a further embodiment, a method for the assembly of an outside mirror arrangement on the basis of a previously described outside mirror arrangement is additionally provided.

The assembly method in this case is characterized by at least a series of steps following one another. In a first step, a previously described outside mirror arrangement with a sealing part detachably fastened thereon is provided. In a further step, the sealing part is initially detached, for example manually from the seal of the fastening element of the outside mirror arrangement. In a subsequent step, the detached sealing part is initially arranged in a hollow space of the door structure adjoining a mirror connecting region on the body side, before in a last step the fastening element of the outside mirror arrangement and thus the entire outside mirror arrangement is sealingly fastened to the mirror connecting region of the motor vehicle body provided for this purpose, in particular of the door structure.

Through the integrated design of seal and sealing part a separate handling of the sealing part can be omitted from a production point of view. In this regard, the sealing part no longer has to be logistically captured as an individual part or an individual component but through its integration in the seal or in the outside mirror arrangement can reduce the total number of motor vehicle components which have to be provided from a logistical point of view for the motor vehicle final assembly. Furthermore, the detachable advance fastening of the sealing part to the seal of the fastening element or the outside mirror arrangement can provide an assembly simplification.

### BRIEF DESCRIPTION OF THE DRAWINGS

The present invention will hereinafter be described in conjunction with the following drawing figures, wherein like numerals denote like elements, and:

FIG. 1 is a schematic and perspective representation of an outside mirror arrangement with sealing part already detached from the latter;

FIG. 2 is a perspective representation of a mirror connecting region of a motor vehicle door structure on the body side during the separate arrangement of the sealing part in a hollow space provided there;

FIG. 3 is a further representation of the mirror connecting region during the fastening of the fastening element of the outside mirror arrangement;

FIG. 4 is a schematic representation of a motor vehicle provided with the outside mirror arrangement;

FIG. 5 is a simplified and schematic flow diagram of the assembly method of the outside mirror arrangement;

FIG. 6a is a simplified schematic representation of seal and sealing part in the pre-assembly state according to a first embodiment; and

FIG. 6b is a further embodiment of seal and sealing part in a pre-assembly state.

### DETAILED DESCRIPTION

The following detailed description is merely exemplary in nature and is not intended to limit application and uses. Furthermore, there is no intention to be bound by any theory presented in the preceding background or summary or the following detailed description.

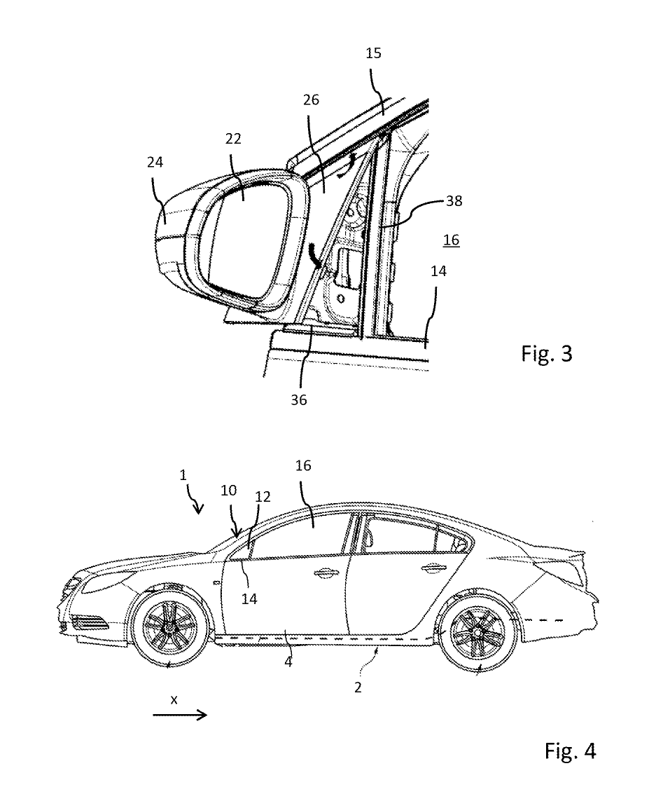

The motor vehicle 1 schematically shown in FIG. 4 comprises a motor vehicle body 2 with a front door structure 4. The door structure 4 comprises a lowerable window 16 and in a region located in travelling direction in front of the latter, a mirror connecting region 12 which is shown enlarged in FIG. 2 and FIG. 3.

The mirror connecting region 12 is limited towards the top by a door profile 15 following the A-pillar 10 of the motor vehicle body 2, in vehicle longitudinal direction (x) by a guide rail 38 for the lowerable window 16 and towards the bottom by a molding strip or by a belt line 14 of the door structure 4. Towards the front, in travelling direction of the motor vehicle 1, the mirror connecting region 12 has a tapering contour. The mirror connecting region 12 can fill out the entire triangle located in travelling direction in front of the guide rail 38, or be formed adjoining a front triangular window of the motor vehicle door structure 4 which is not explicitly shown here.

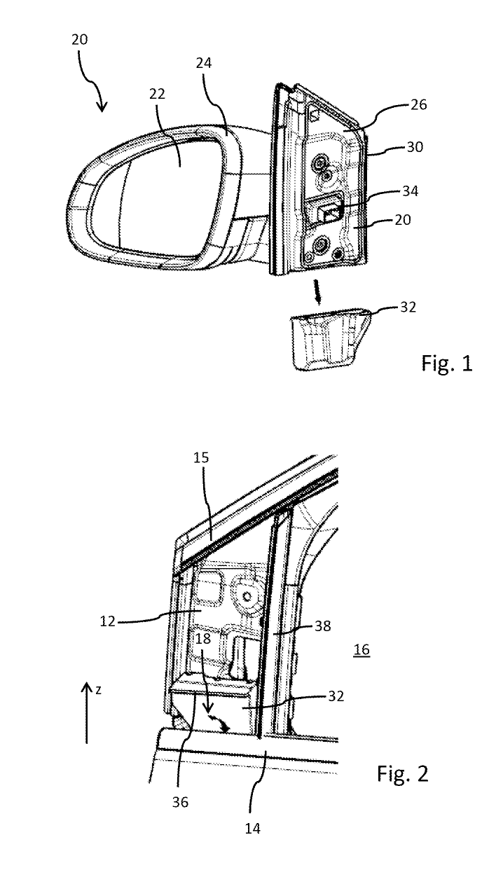

The outer mirror arrangement 20 shown in FIG. 1 isolated in a perspective representation comprises a mirror 22 encased in a mirror housing 24, which via a fastening element 26 formed approximately flange-like can be connected to the mirror connecting region provided on the body side or door structure side. Here, the fastening element 26 is provided in particular with a surrounding seal 30, with which the outer mirror arrangement 20 or its fastening element 26 can be sealingly fastened to or opposite the adjoining components of the door structure 4, thus for example on the door profile 15, on the guide rail 38 and on the window well-side belt line 14 or a molding strip provided there.

FIG. 1 furthermore shows a plug connection 34 sealed in circumferential direction, via which a servomotor for example provided within the mirror housing 24 is activatable for moving the mirror 22. In a pre-assembly state which in FIG. 6a and FIG. 6b is merely shown in a simplified manner, the seal 30 provided on the fastening element 26 is connected to a separate sealing part 32 via a connecting region 40. The sealing part 32 in said pre-assembly state can for example be formed as an extension of the seal 30 and project approximately from the lower lateral edge of the seal 30 or from the lower lateral edge of the fastening element 26 formed correspondingly thereto.

However, a starting situation sketched for example in FIG. 6b is also conceivable, in which the connecting region 40 is not formed in a straight line but rather curved, so that the detachable sealing part 32 extends at a predetermined angle to the plane of the seal 30. Such an angled or tilted configuration of seal 30 and sealing part 32 can be advantageous for a one-piece or combined production process of seal 30 and sealing part 32, for example if the seal 30 and the associated sealing part 32 are formed in the manner of a thermally activatable plastic molding.

The sealing part 32 is to be detached on the seal 30 prior to a final assembly of the outside mirror arrangement 20. To this end, the connecting region 40 provided between seal 30 and the sealing part 32 can provide at least one predetermined breaking point or one predetermined breaking line and in this regard form a structural weakening of the composite of seal 30 and sealing part 32. Thus, in particular by applying a peeling force which is above a defined threshold value, a well-defined and predetermined separating of seal 30 and sealing part 32 can take place, wherein the seal 30 and the sealing part 32, considered in isolation, each remain intact.

The detached sealing part 32 is formed in particular for arrangement in a hollow space 18 of the door structure 4 indicated in FIG. 2, which, based on the vehicle vertical axis (z) is located below the mirror connection region 12 on the body side provided for the outside mirror assembly. That hollow space 18, in a manner of speaking is an extension of the window well receiving the lowerable window 16 which is not separately shown here.

In that the sealing part 32 is formed as an elastic molding, it can largely fill out completely the hollow space 18 of the door structure 4 formed approximately between door outer paneling and door inner covering and thus counteract any resonance phenomena or vibration manifestations during the operation of the motor vehicle 1. In addition, the sealing part 32 can be provided with a flange 36 schematically indicated in FIG. 2 and FIG. 3 and in the final assembly state on the motor vehicle body 2 substantially extending in vehicle transverse direction (y) to the outside, by means of which the hollow space 18 can be effectively sealed off against a molding strip or against the belt line 14 formed by the molding strip. As is shown for example in FIG. 3, said flange 36 projecting outwardly can come to lie on the trim molding or the belt line 14 of the door structure 4. In a following assembly step, the remaining outside mirror arrangement 20 can then be arranged with its fastening element 26 in the mirror connecting region 12 of the door structure 4 provided for this purpose and fastened there as intended.

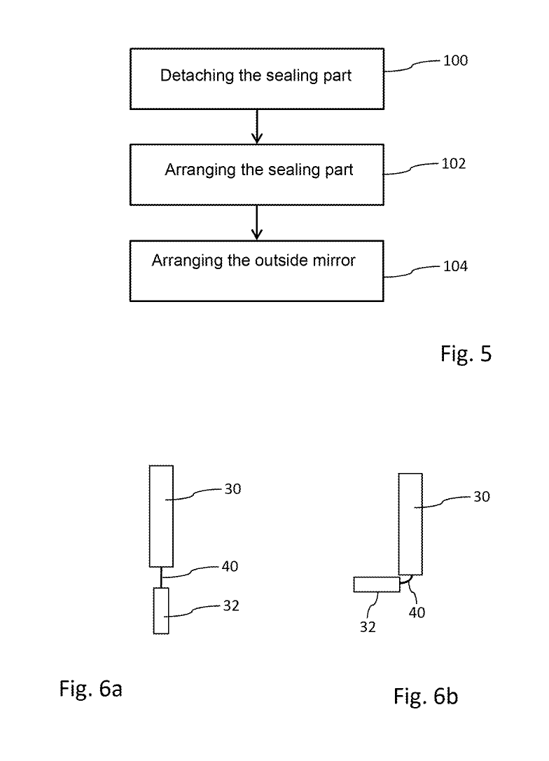

FIG. 5 finally shows schematically three method steps for the assembly of the outside mirror arrangement 20 on the motor vehicle body 2. Since the outside mirror arrangement 20 is provided with a sealing part 32 detachably fastened thereon, the sealing part 32 in a first step 100 can be initially detached and separated from the outside mirror arrangement or from the seal 30 provided on and preferably attached to the fastening element 26 of the outside mirror arrangement 20 in a positively joined manner.

Following an intended, preferably irreversible detaching of the sealing part 32 of the seal 30, the sealing part 32 in the step 102 can be separately arranged on the motor vehicle body 2, in particular in a hollow space 18 of the door structure 4. In a following step 104, the outside mirror arrangement 20 can then be fastened to the mirror connecting region 12 of the door structure on the body side in the manner sketched in FIG. 3.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. An outside mirror arrangement for a motor vehicle, comprising:
a mirror;
a mirror housing encasing the mirror;
a fastening element that is configured to seal fasten the mirror housing on a motor vehicle body, the fastening element comprise:
a seal on which in a pre-assembly state of the outside mirror arrangement a sealing part is detachably fastened, which can be separately fastened to the motor vehicle body prior to fastening the mirror housing to the motor vehicle body.

2. The outside mirror arrangement according to claim 1, wherein the sealing part and the seal in the pre-assembly state of the outside mirror arrangement are connected to one another in a positively manner.

3. The outside mirror arrangement according to claim 1, wherein the sealing part and the seal in a pre-assembled state of the outside mirror arrangement are formed in one piece.

4. The outside mirror arrangement according to claim 1, wherein the sealing part is connected to the seal via at least one predetermined breaking point.

5. The outside mirror arrangement according to claim 1, wherein the sealing part in the pre-assembly state of the outside mirror arrangement projects from the seal.

6. The outside mirror arrangement according to claim 1, wherein the seal encloses the fastening element substantially in a circumferential direction.

7. The outside mirror arrangement according to claim 1, wherein the sealing part that is separated from the seal is insertable in a hollow space formed below a mirror connecting region on a body side.

8. The outside mirror arrangement according to claim 1, wherein the sealing part projects from an outer circumference of the seal.

9. The outside mirror arrangement according to claim 1, wherein the sealing part in a final assembly state is arrangeable on the motor vehicle body in a region of a belt line of the motor vehicle body directly adjoining the seal of the fastening element fastened to the motor vehicle body.

10. The outside mirror arrangement according to claim 1, wherein the seal is a foamed plastic molding.

11-12. (canceled)

13. A method for assembly of an outside mirror arrangement on a motor vehicle body, comprising:
detaching a sealing part of the outside mirror arrangement from the seal of the outside mirror arrangement;
arranging the sealing part in a hollow space adjoining a mirror connecting region on a body side; and
sealing fastening of a fastening element of the outside mirror arrangement to the mirror connecting region.

14. The outside mirror arrangement according to claim 1, wherein the sealing part in the pre-assembly state of the outside mirror arrangement projects from the fastening element.

15. The outside mirror arrangement according to claim 1, wherein the sealing part projects from an outer circumference of the fastening element.

16. The outside mirror arrangement according to claim 1, wherein the sealing part is a foamed plastic molding.
